(19) United States
(12) Patent Application Publication
(10) Pub. No.: US 2018/0256451 A1
(43) Pub. Date: Sep. 13, 2018

(54) INFANT SOLID FOOD TRANSITIONAL NIPPLE ADAPTER

(71) Applicant: Jennifer Sinicrope, Sugar Land, TX (US)

(72) Inventor: Jennifer Sinicrope, Sugar Land, TX (US)

(21) Appl. No.: 15/907,342

(22) Filed: Feb. 28, 2018

Related U.S. Application Data
(60) Provisional application No. 62/468,119, filed on Mar. 7, 2017.

(51) Int. Cl. A61J 9/00; A61J 11/04

(52) U.S. Cl. CPC A61J 9/00; A61J 11/0035; A61J 11/04

(57) ABSTRACT

A nipple adapter for feeding babies solid food from a milk nipple they already use for milk is disclosed. A nipple adapter is screwed onto a food pouch and into a milk nipple such that the food from the pouch can be fed to the baby through the milk nipple the baby already uses for milk.

### BACKGROUND

The present disclosure is directed to baby feeding accessories and, more particularly, a baby bottle nipple adapter for transitioning a young baby from feeding on liquid to feeding on solid food from a dispensing pouch. Babies with food aversions, developmental delays, or oral sensory disorders have difficulty finding the solid food transition tolerable especially because of the introduction of unfamiliar feeding accessories. Traditionally, the only way to feed a baby solid food out of a food pouch who dealt with such food aversions, developmental delay and oral sensory disorders was to endure the frustration and crying that goes along with it.

More recently, devices to address this problem have come in two forms: an elongated silicone nipple or a short non-spill silicone nipple. The elongated silicone nipple is placed directly onto the pouch top. Said silicone nipple, however, this approach does not work well because of its tendency to spill the contents of the pouch when the pouch is squeezed, furthermore the spout is unfamiliar to the baby. The second device is a short silicone non-spill nipple that is difficult for a young baby to learn to suck from because they don't have the sucking strength required to breach the nonspill seal, moveover the spout is unfamiliar to the baby.

As can be seen, there is a need for a baby bottle nipple adapter for a food dispensing pouch so that the familiar nipple of the baby bottle is also the transport for the food out of the new food pouch, wherein the nipple adapter is configured to prevent spills and make it easy for the baby to suck through.

### SUMMARY

Various features of the present disclosure are described herein. Embodiments of the present disclosure are directed toward a nipple adapter having an interior bore with female attachment means having a first diameter configured to receive a male attachment means from a food pouch, and an exterior surface with male attachment means having a second diameter configured to couple with a milk nipple. The nipple adapter in which the attachment means are threaded attachment means, and the pitch and diameter of the threads of the female attachment means are configured to match the food pouch and the pitch and diameter of the threads of the male attachment means are configured to match the milk nipple.

Other embodiments are directed toward a method of coupling a milk nipple to a solid food pouch, the method including providing a nipple adapter. The nipple adapter includes threaded, interior, female bore, a top side, and a bottom side. The bore extends from the top side to the bottom side. The nipple adapter also includes a threaded, exterior, male connector extending between the top side and the bottom side. The method further includes attaching the nipple adapter to a food pouch via the bore, the food pouch having a male threaded nozzle that is operably coupled to the bore, and attaching the nipple adapter to a milk nipple via the male connector, the milk nipple having female threaded connection means that are operably coupled to the male connector of the nipple adapter.

Further embodiments of the present disclosure are directed to a nipple adapter, comprising a threaded, interior, female bore, a top side, and a bottom side. The bore extends from the top side to the bottom side. The nipple adapter also includes a threaded, exterior, male connector extending between the top side and the bottom side. The nipple adapter is configured to be attached to a food pouch via the bore, the food pouch having a male threaded nozzle that is operably coupled to the bore. The nipple adapter is configured to be attached to a milk nipple via the male connector, the milk nipple having female threaded connection means that are operably coupled to the male connector of the nipple adapter.

### BRIEF DESCRIPTION OF THE FIGURES

FIG. 1 is a top plan view of an embodiment according to the present disclosure.

FIG. 2 is a perspective view of an embodiment according to the present disclosure.

FIG. 3 is an elevational view of an embodiment according to the present disclosure.

FIG. 4 is an elevational view of an embodiment according to the present disclosure.

FIG. 5 is an elevational view of an embodiment according to the present disclosure.

FIG. 6 is a top plan view of an embodiment according to the present disclosure.

FIG. 7 is an elevational view of an embodiment according to the present disclosure.

FIG. 8 is a perspective view of an embodiment according to the present disclosure.

FIG. 9 is an elevational view of an embodiment according to the present disclosure.

FIG. 10 is a perspective view of an embodiment according to the present disclosure.

FIG. 11 is a perspective view of an embodiment according to the present disclosure.

### DETAILED DESCRIPTION

Below is a detailed description according to various embodiments of the present disclosure. In some embodiments the present disclosure is directed to a nipple adapter having an annular body providing external and internal circumferential threadings, wherein the external threading securely mates to desired nipple and a retainer collar (that a baby is familiar with when feeding from a baby bottle) to the nozzle of a baby food pouch via the internal threading, when transitioning a baby to feeding on food from the pouch.

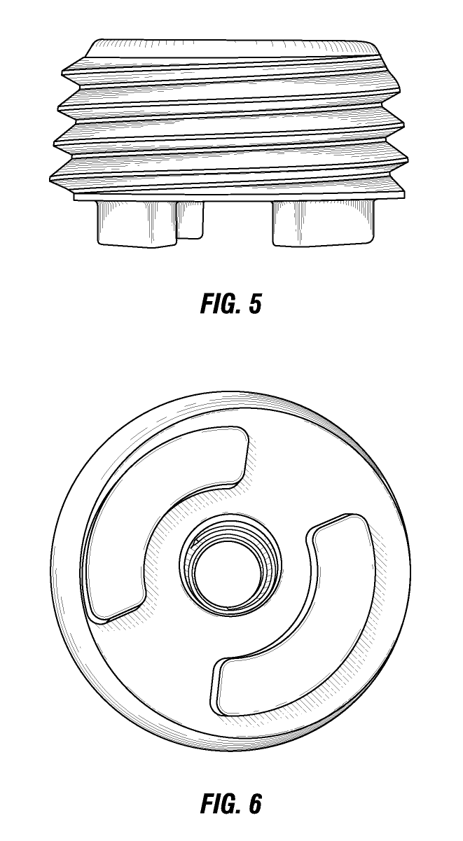

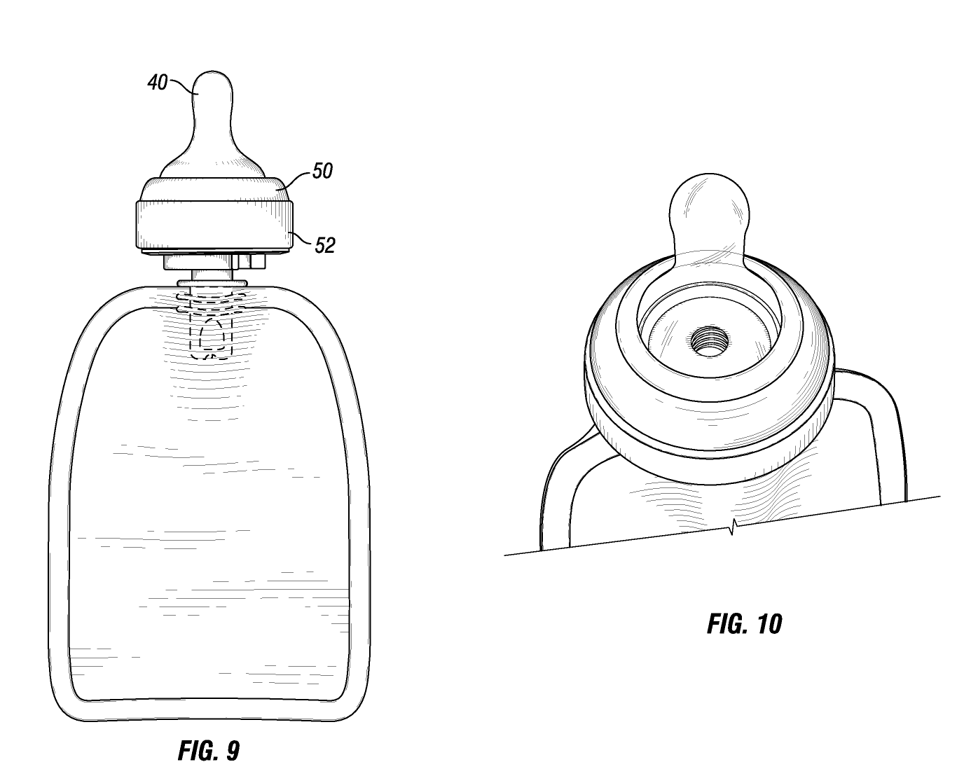

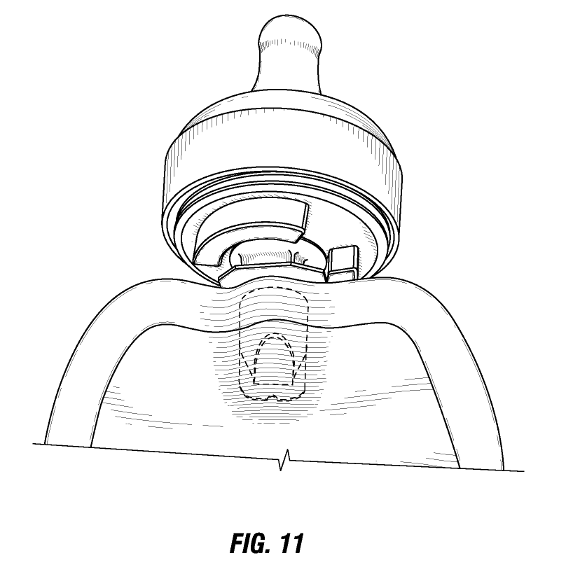

Referring now to FIGS. 5 through 11, baby bottles typically provide a desired nipple 40 and a retainer 50, as illustrated in FIG. 9. The retainer 50 provides a ring 52 with an upper wall having a hole for slidably receiving a dispensing end of the desired nipple 40, while the remainder of the upper wall bears down on the radially extending flange of the desired nipple 40. The retainer 50 provides a set of internal retainer threads located on the interior side of its ring 52. The internal retainer threads are dimensioned and adapted to securely mate with external bottle threads along the exterior of the opening of the baby bottle.

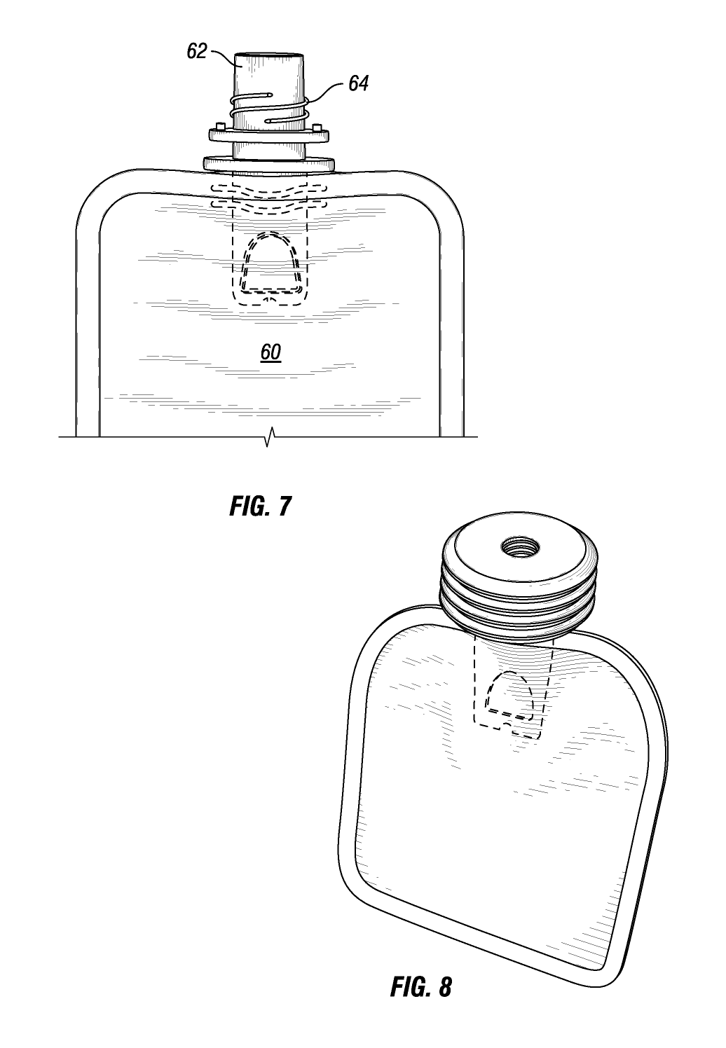

Food dispensing bags 60 are known as squeeze-pouches. They typically have an elongated nozzle 62 having external peripheral nozzle threading 64, as illustrated in FIG. 7. While the elongated nozzle 62 tends to the approximate girth of the nipple 40, the ring 52 tends to have a girth at least twice that of the desired nipple 40. Many of these nozzles are sold with a removable cap with a frangible seal (not shown). There are many producers of these products but the general shape is very similar if not identical. There are many adapters which are made to attach to the top of the squeeze pouch; however, all of these suffer the same flaw: they introduce a new object that is different from the nipple the baby has been using previously to drink milk. The nipple adapter 10 of the present disclosure allows the parent to use the same exact nipple with which the baby is already familiar.

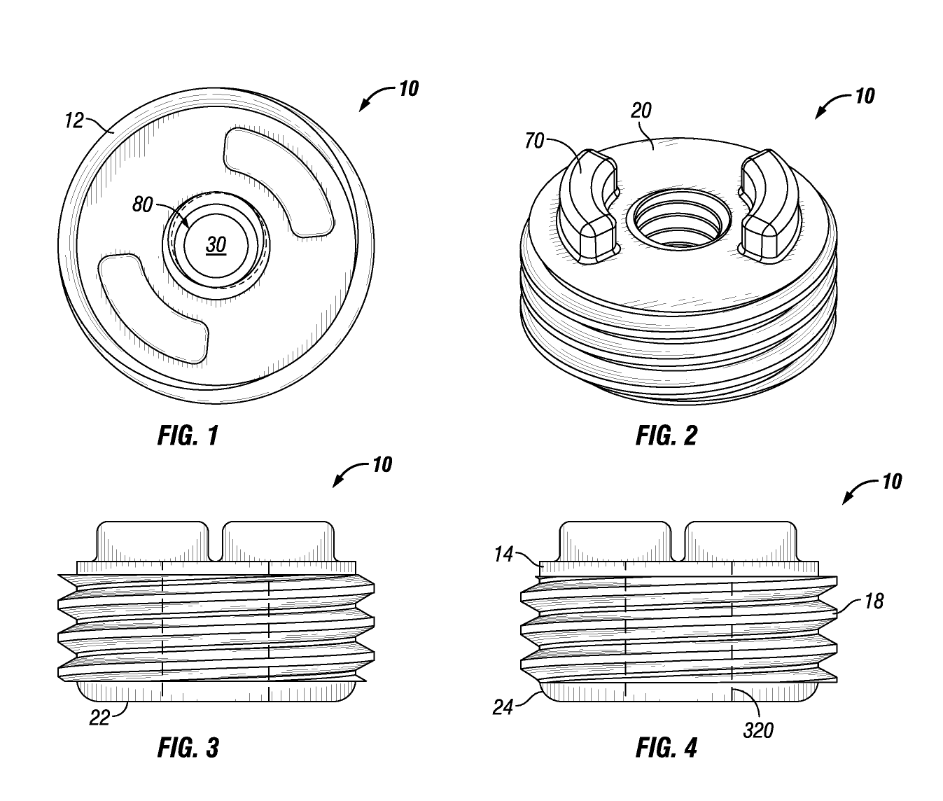

Referring now to FIGS. 1 through 4, embodiments of the present disclosure are directed to a nipple adapter 10 having an annular body 12. The annular body 12 may be made of elastic material, such as but not limited to, silicone, rubber, plasticized materials and the like. Along the outer circumferential edge 14 of the annular body 12, the nipple adapter 10 may provide external adapter threading 18 dimensioned and adapted to securely mate with the internal retainer threads of the retainer 50. In some embodiments, the external adapter threading 18 may have a 3 cm-10 cm in diameter. The circumferential edge 14 may be defined by a first and opposing second surfaces, 20 and 22 respectively. An aperture 30 may be centrally disposed in the annular body 12 so as to communicate the first and second surfaces 20 and 22. The aperture 30 may provide aperture threading 32 dimensioned and adapted to securely mate with the external peripheral nozzle threading 64. In certain embodiments, the aperture threading 32 may have a 1 cm-3.5 cm in diameter. The aperture 30 may provide a thread stop 80 at the top of the inside thread to create a seal at the center where a food pouch will fit, preventing leaking. It is understood that a food pouch may be a solid food, liquid food, or a pureed food dispenser. The second surface 22 may form a dome shape with curved interface 24, wherein the dome shape is dimensioned and adapted to seal the nipple adapter 10 to the baby bottle, for example the upper wall of the retainer 50, wherein the dome shape acts as an O-ring.

The nipple adapter 10 may provide a plurality of grips 70 spaced along and extending generally transverse from the first surface 20, as illustrated in FIG. 2. The plurality of grips 70 may be dimensioned and adapted to enable a user to obtain a grip and/or leverage to screw the nipple adapter 10 into the retainer 50. In some embodiments, each grip 70 may be 0.5 cm×2 cm−2 cm×4 cm in diameter.

A method of using the nipple adapter 10 and other components of the present disclosure may include the following. The 20 nipple adapter 10 disclosed above may be provided. A user may match the nipple adapter 10 to a predetermined bottle brand and type. Then the user may screw the nipple adapter 10 onto the desired baby food pouch and utilizing the babies' familiar desired nipple 40, for example a Y or X or variable flow nipple that the user's baby can comfortably take in the baby food. The aperture threading 32 may be screwed onto the elongated nozzle 62 and thus attaching to the baby food pouch 60, whereby the thread stop 80 creates a seal along the elongated nozzle 62. The customer then may utilize their existing baby bottle retainer 50 and desired nipple 40, by screwing the former onto the external threading 18, wherein the dome shape 24 at the top seals the nipple adapter 10 to the retainer 50 upper wall and/or flange of the desired nipple 40. Thereby the apparatus of the present disclosure achieves a much more pleasant feeding experience or at the very least, limits the opposition experienced by allowing the consumer to utilize their existing, familiar bottle nipple and collar. When removing the nipple adapter and collar/retainer 50, the user may find it beneficial to hold onto the grips 70 to assist with the unscrewing motion.

Adapters in general from one threaded connection to another threaded connection are known in the art. However, there has not been a product in the market that can achieve the goals that the nipple adapter of the present disclosure. Specifically, the nipple adapter of the present disclosure allows the parent to use the same exact nipple they were using for milk. The baby will not perceive any change because none has been made. Only the material coming through the nipple is different. Sensitive babies will and have enjoyed using the nipple adapter of the present disclosure with great success not previously found with other products.

It should be understood, of course, that the foregoing relates to embodiments of the present disclosure and that modifications may be made without departing from the spirit and scope of the disclosure. The foregoing disclosure hereby enables a person of ordinary skill in the art to make and use the disclosed systems without undue experimentation. Certain examples are given to for purposes of explanation and are not given in a limiting manner. Dimensions are given in this specification and in the figures for purposes of explaining the embodiments of the present disclosure and are not given in a limiting way.

1. A nipple adapter having an interior bore with female attachment means having a first diameter configured to receive a male attachment means from a food pouch, and an exterior surface with male attachment means having a second diameter configured to couple with a milk nipple.

2. The nipple adapter of claim 1 wherein the attachment means are threaded attachment means and wherein the pitch and diameter of the threads of the female attachment means are configured to match the food pouch and the pitch and diameter of the threads of the male attachment means are configured to match the milk nipple.

3. The nipple adapter of claim 1 wherein the first diameter is approximately half the second diameter.

4. The nipple adapter of claim 1 wherein the nipple adapter has a top side facing toward the milk nipple and a bottom side facing toward the food pouch, the nipple adapter further comprising grips extending from the bottom side.

5. The nipple adapter of claim 1 wherein the nipple adapter is configured to fit within the milk nipple.

6. The nipple adapter of claim 1 wherein the milk nipple comprises a nipple portion and a ring portion.

7. The nipple adapter of claim 6 wherein the nipple adapter is configured to fit within the ring portion with the ring portion and the nipple adapter enclosing a portion of the nipple to seal the nipple to the nipple adapter.

8. The nipple adapter of claim 7, the nipple adapter further comprising grips which extend downwardly out of the ring portion to allow the nipple adapter to be rotated relative to the ring portion to threadably seal the nipple adapter to the ring portion.

9. A method of coupling a milk nipple to a solid food pouch, the method comprising:
providing a nipple adapter, the nipple adapter having:
a threaded, interior, female bore;
a top side;
a bottom side, wherein the bore extends from the top side to the bottom side;
a threaded, exterior, male connector extending between the top side and the bottom side;
attaching the nipple adapter to a food pouch via the bore, the food pouch having a male threaded nozzle that is operably coupled to the bore; and
attaching the nipple adapter to a milk nipple via the male connector, the milk nipple having female threaded connection means that are operably coupled to the male connector of the nipple adapter.

10. The method of claim 9, further comprising dispensing food from the food pouch through the nipple adapter and into the milk nipple.

11. A nipple adapter, comprising:
a threaded, interior, female bore;
a top side;
a bottom side, wherein the bore extends from the top side to the bottom side;
a threaded, exterior, male connector extending between the top side and the bottom side;
wherein the nipple adapter is configured to be attached to a food pouch via the bore, the food pouch having a male threaded nozzle that is operably coupled to the bore; and
wherein the nipple adapter is configured to be attached to a milk nipple via the male connector, the milk nipple having female threaded connection means that are operably coupled to the male connector of the nipple adapter.

12. The nipple adapter of claim 11, further comprising grips configured to allow the nipple adapter to be screwed onto the milk nozzle.

13. The nipple adapter of claim 11 wherein the nipple adapter is made of a flexible material.
